(19) United States
(12) Patent Application Publication
(10) Pub. No.: US 2014/0089778 A1
(43) Pub. Date: Mar. 27, 2014

(54) Progressive Image Rendering Utilizing Data URI Enhancements

(71) Applicant: Amazon Technologies, Inc, (US)

(72) Inventor: Andrew Hayden, Seattle, WA (US)

(73) Assignee: Amazon Technologies, Inc, Reno, NV (US)

(21) Appl. No.: 13/625,667

(22) Filed: Sep. 24, 2012

(51) Int. Cl. G06F 17/00

(52) U.S. Cl. 715/234

(57) ABSTRACT

Architectures and techniques for providing an initial portion of media content of a network site to a user equipment. One technique includes embedding an initial portion of the media content within hypertext markup language (HTML) for displaying a page of the network site. A uniform resource identifier (URI) is embedded within the HTML for displaying the page of the network site that includes the media content, where the URI indicates a location of the media content. The HTML including the initial portion of the media content and the URI is provided to the user equipment for displaying the page of the network site that includes the media content on the user equipment.

### BACKGROUND

As access to networks, such as, for example the Internet, continue to increase, the desire to improve performance while efficiently utilizing bandwidth also increases. For example, when accessing a network site over a network, the speed with which the pages at the network site load provide an improved experience for users. Downloading of pages at various network sites over a network can be hindered by the inability to properly layout a page quickly due to text and media content at the page. Additionally, users will often access pages on various network sites and have little or no interest in media content within the pages. Thus, providing high quality and/or high definition media content at various pages can be a waste of bandwidth for such users.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 schematically illustrates an example of an environment for accessing network sites over a network.

FIG. 2 illustrates a process of providing media content from a network site to a user equipment.

FIG. 3 illustrates a process of receiving media content from a network site.

### DETAILED DESCRIPTION

This disclosure describes architectures and techniques for accessing network sites, such as websites, over a network such as, for example, the Internet, intranets, etc., where the language for displaying the network site on a user's equipment includes a portion of media content for a page of the network site. Thus, the language for the network site, generally in the form of a Hyper Text Markup Language (HTML), includes a data uniform resource identifier (URI) embedded therein. HTML is the main markup language for displaying web pages and other information that can be displayed via an application such as, for example, a web browser.

In accordance with the present disclosure, a binary artifact is also included in the HTML so that the user's application, such as a web browser, can finish downloading the media content. An artifact in the Unified Modeling Language (UML) is the specification of a physical piece of information that is used or produced by a software development process, or by deployment and operation of a system. Examples of artifacts include model files, source files, scripts, binary executable files, a table in a database system, a development deliverable, a word-processing document, a mail message, etc. Thus, as an example, a user accesses a website over the Internet via a web browser on a computing device. As the first page of the website downloads to the computing device, an initial portion of media content on the first page, for example an image, is provided to the web browser of the user's computing device via a data URI embedded within the HTML. The initial portion of media content is displayed to the user along with other portions of the page such as, for example, text. This allows for the web browser to more quickly layout the page of the website and thus, provides an improved page loading experience and page loading time for the user. The web browser can download the remaining portion of the image to provide a higher quality and/or higher definition version of the image based upon a binary artifact within the HTML for the page.

Many image formats, such as, for example, JPEG and PNG, include ‘progressive’ modes that result in lower-resolution ‘layers’ of the image being loaded first with improving levels of detail being rendered as they are progressively downloaded. For example, with a 100K progressive JPEG a web browser can render a low-quality version of (first layer) by downloading only the first 2-3K of image data. Thus, in accordance with the present disclosure, progressive images are utilized, with the first few layers embedded within the HTML for the website to provide the initial portion of the image.

In accordance with the present disclosure, only the initial portion of the media content may be provided to the web browser. For example, the user may not have any interest or desire in the media content located on the page. For example, an image may not interest the user and thus, the initial portion of the image may be all that is necessary to be provided to the web browser. As previously noted, in accordance with the disclosure, such an initial portion of an image provided by the data URI may be generally a lower resolution and/or lower quality. Thus, unless the user performs some sort of trigger such as, for example, attempting to zoom in on the image or select the image for some other purpose, then the web browser may not complete the downloading of the image and thus, not provide a better quality, higher resolution version of the image. The user can also set preferences within the web browser to allow for automatically providing or ignoring completing downloading of the media content based upon factors such as the desire to view media content in better quality, performance of the computing device, bandwidth issues, data limitations etc.

In accordance with the present disclosure, a server, such as a proxy server, may obtain cacheable media content from a network site when a user first accesses a network site via the proxy server. The proxy server can provide the initial portion of the media content to the user when the user's web browser connects to the network site via the proxy server. The proxy server may obtain the entire media content based upon a binary artifact included in the HTML and provide the entire media content to the user, based upon the user's preferences, but may also store the media content within cache of the proxy server regardless of whether the entire media content is provided to the user. When other users subsequently access the network site via the proxy server, the proxy server can provide the initial content of the media content via the data URI within the network site's HTML and can also, depending upon the subsequent user's preferences, provide the remaining portion of the media content to the subsequent user from the cache within the proxy server, thereby improving page loading performance for the subsequent user.

### Example Architectures

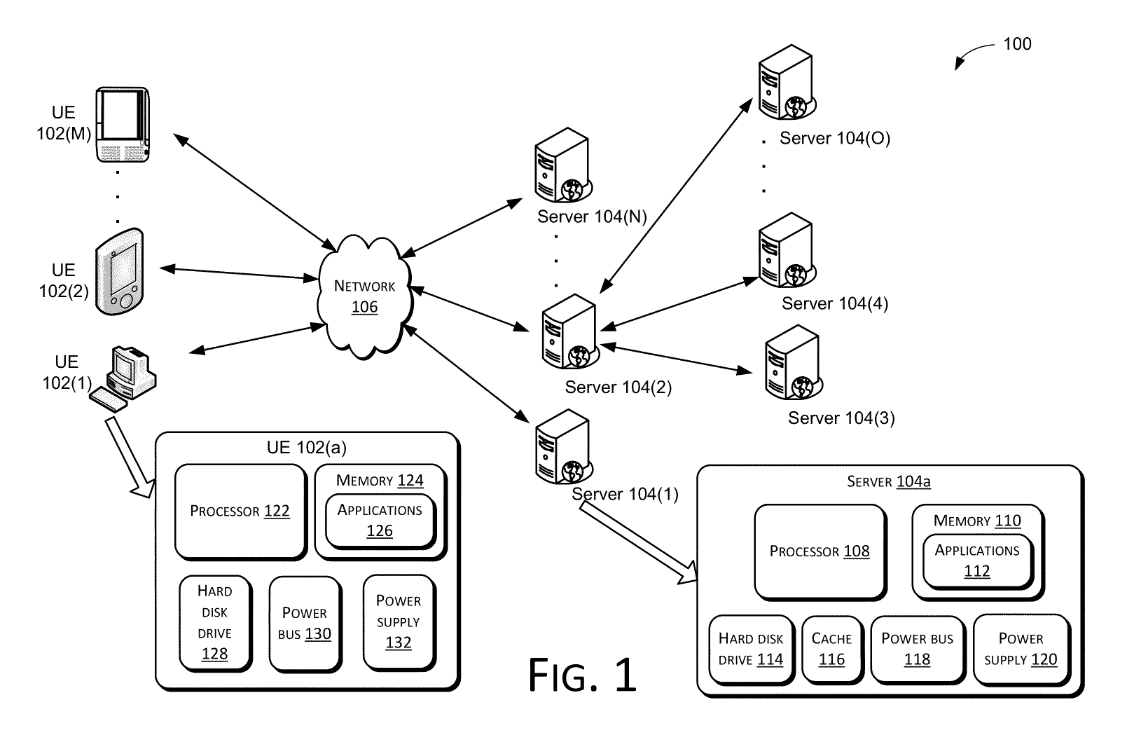

FIG. 1 illustrates an environment 100 for implementing the aforementioned techniques for accessing network sites, such as websites, over a network such as, for example, the Internet, intranets, etc., where the language for displaying the network site on user equipment or a user device accessing the network site includes a portion of media content for a page of the network site. Thus, the environment of FIG. 1 includes a plurality of user equipments (UEs) 102(1), 102(2), . . . , 102(M). The UEs 102 can include, for example, desktop computers, laptop computers, personal digital assistants, notebooks, cellular telephones, etc. This list of UEs 102 is not meant to be limiting.

The environment 100 also includes a plurality of computing devices or hosts represented as one or more servers 104(1), 104(2), . . . , 104(N), which may include both resources and functionality. The UEs 102 can couple to and communicate with the servers 104 via a network 106 such as, for example, the Internet or an intranet. The servers 104 are generally configured to serve as network site providers by hosting network sites. One or more of the servers 104 may serve as a proxy server. A proxy server is generally a server (a computer system or an application) that acts as an intermediary for requests from UEs seeking resources from other servers. A UE connects to the proxy server, requesting some service, such as a file, connection, web page, or other resource available from a different server. In the example environment 100 of FIG. 1, server 104(2) is illustrated as serving as a proxy server communicating with servers 104(3), 104(4), . . . , 104(O).

Additionally, a network-accessible computing platform (not illustrated), often referred to as a “cloud-computing platform” or a “cloud-computing environment” may be configured to serve as a network site provider by hosting network sites. Such network-accessible computing platforms may include one or more servers 104 and may utilize other types of computing devices as opposed to, or included with, the servers 104.

The computing devices available to provide services as hosts within the environment 100 may be in the form of dedicated servers, shared servers, virtual servers, server slices, processors, processor cycles, and so forth. While FIG. 1 illustrates the computing devices in the form of servers 104, this is not meant to be limiting and is presented as such simply for ease and clarity. One or more of the servers 104, including the one or more proxy servers, can be included within a network accessible computing platform.

As illustrated, the servers 104 (represented generally as server 104a) generally include one or more processors 108 and memory 110, which may comprise any sort of computer-readable storage media and may store one or more applications 112. The memory 110 may be in the form of one or more hard disk drives 114 and may also include other types of memory, such as, for example, cache 116. The applications 112 may be utilized to perform various functions associated with hosting network sites and providing various content associated with the network sites. The servers 104a may also include one or more other components typically found in computing devices, such as communication connections, input/output I/O interfaces, and the like. The servers 104a also generally include one or more power busses 118 and one or more power supplies 120.

As illustrated, the UEs 102 (represented generally as UE 102a) generally include one or more processors 122 and memory 124, which may comprise any sort of computer-readable storage media and may store one or more applications 126. The memory 124 may be in the form of one or more hard disk drives 128 and may also include other types of memory. The applications 126 may be utilized to perform various functions associated with accessing network sites and receiving various content associated with the network sites. Thus, in general, one of the applications 126 is typically in the form of a browser, such as a web browser. The UEs 102a may also include one or more other components typically found in computing devices, such as communication connections, input/output I/O interfaces, and the like. The UEs 102a also generally include one or more power busses 130 and one or more power supplies 132.

A UE 102 is utilized by a user to access the network 106 such as, for example, the Internet or an intranet, via a web browser. The network 106 is utilized to access one or more servers 104 that include various network sites for providing content to the user via the UE 102. Content can include, but is not limited to, texts, images, videos, audio, etc. Thus, as is known, users utilize the UEs 102 to access the servers 104 via the network 106 in order to access web pages, websites, and/or internal pages and network sites of an internal system such as an intranet.

The browser can also be implemented in such a manner that one or more, even all, of the functions of the browser are performed by one or more of the servers 104. Such a browser uses a split architecture whereby some of the processing is performed on one or more servers 104 and some of the processing is performed by the UE 102. Thus, one of the applications 112 in the servers 104 and one of the applications 126 in the UEs 102 may include such a browser.

### Example Operations

In accordance with the present disclosure, the language for a network site, generally in the form of HTML, includes a data URI directly embedded therein. Additionally, a binary artifact is also included in the HTML. A data URI scheme allows for the inclusion of binary data inline within HTML instead of referencing that binary data via a location, i.e. a URI. For example, assume a small JPEG is to be included on a network site. A conventional way to do include the JPEG on the network site is to reference the location of a binary artifact, e.g.: img src=‘/tiny_image.jpg’. As previously noted, an artifact in the Unified Modeling Language (UML) is the specification of a physical piece of information that is used or produced by a software development process, or by deployment and operation of a system. Examples of artifacts include model files, source files, scripts, and binary executable files, a table in a database system, a development deliverable, or a word-processing document, a mail message.

With data URI, one can include the actual binary content as a base64-encoded string, e.g.: img irc=‘data:image/jpeg;base64,[base-64-binary-content-here]’. While, data URI requires textual encoding of binary data, one can avoid having to make a separate hypertext transfer protocol (HTTP) request for the image itself.

Many image formats, such as, for example, JPEG and PNG, include “progressive” modes that result in lower-resolution “layers” of the image being loaded first with improving levels of detail being rendered as they are progressively downloaded. In particular, a simple or “baseline” JPEG file is stored as one top-to-bottom scan of the image. Progressive JPEG divides the file into a series of scans. The first scan shows the image at the equivalent of a very low quality setting, and therefore it takes very little space. Subsequent scans gradually improve the quality of the image. Each scan adds to the data already provided, so that the total storage requirement is roughly the same as for a baseline JPEG image of the same quality as the final scan. In other words, progressive JPEG is a rearrangement of the same data into a more complicated order. Thus, with a 100K progressive JPEG a web browser can render a low-quality version of (first layer) by downloading only the first 2-3K of image data.

In accordance with the present disclosure, the first few kilobytes, which probably represent the first few layers of detail in a progressive image, are included in a data URI that is embedded directly in the HTML. A URI is also included in the HTML so that the web browser can go to the network site where the image is located in order to finish downloading the rest of the image. The HTML may also include an offset at which to start transferring the remainder of the image. For example, the HTML may be:

img src=‘/big_image.jpg’x-src=‘data:image/jpeg;base64,[low-res-first-layer-base64-encoded]’

The “src” attribute is used to reference a completely normal progressive JPEG. Thus, if the web browser doesn't support data URI and/or there is a problem with the data in the data URI, the entire image can still be displayed normally. Additionally, the first few kilobytes (headers and first couple layers) of the JPEG image in the data URI itself is included in the “x-src” attribute. The web browser can decode this inline and display the low-resolution layers immediately without using the “src” attribute. Also, the browser can calculate the number of bytes decoded from the data URI and use that as the offset at which to start the transfer of the remaining data for the “src” URI (/big-image.jpg). This allows the browser to download only the bytes of “big-image.jpg” that the browser does not already possess via the data URI. If the browser or the server at which the network site is located is incapable of using offsets for transfers, the entire image can be transferred (with some redundancy) and the first bytes can be ignored. It is noted that use of the attribute name “src” is merely an example and the name of the attribute can be different. Thus, use of the attribute name “src” is not meant to be limiting.

Thus, the embedding of the first few thousand bytes of data in a data URI allows the browser to complete its layout work completely (i.e., by calculating the size of the image) upon initially accessing a network site and provides the user with something to look at very quickly, but still allows for the full-resolution image to be transferred without any redundancy. With the inclusion of a URI for the entire image, these techniques are backwards compatible with browsers that don't support data URI, as well as servers that don't support HTTP requests with a byte-offset. These techniques can be used by proxy servers to rewrite HTML on-the-fly, and therefore can be included in an intelligent HTTP proxy server. Additionally, while the present disclosure has been described with respect to images, the techniques may be used for other forms of media content such as, for example, video content, and/or audio content.

In accordance with the present disclosure, only the initial portion of the media content may be provided to the browser. For example, a user may not have any interest or desire in the media content located on the page. As an example, an image may not interest the user and thus, the initial portion of the image may be all that is necessary to be obtained by the browser. As previously noted, in accordance with the present disclosure, such an initial portion of an image provided by the data URI may generally be of a lower resolution and/or lower quality. Accordingly, the user may perform some sort of “trigger” such as, for example, attempting to zoom in on the image or select the image for some other purpose, in order to indicate a desire to receive more of the image or a better quality version of the image. In response to such a trigger, then the browser may complete the downloading of the image and therefore, may provide a better quality, higher resolution version of the image. The user can also set preferences within the browser to allow for automatically ignoring or completing downloading of media content based upon factors such as the desire to view media content in better quality, performance of a UE 102, bandwidth issues, data limitations, etc. The remaining portion of the media content can also be provided to the user automatically after a predetermined amount of time. Additionally, based upon heuristic models, the remaining portion of the media content can be automatically provided to the user. The heuristic models can be based upon, for example, user preferences, popularity among multiple users, (i.e. the media content is popular among multiple users), etc. The media content can include, for example, images, video content and/or audio content.

In accordance with the present disclosure, a server 104, such as a proxy server 104, may obtain cacheable media content from a network site when a user, with a UE 102, first accesses the network site via the proxy server 104. The proxy server 104 can provide the initial portion of the media content to the UE 102 when the UE's browser connects to the network site via the proxy server 104. The proxy server 104 may obtain the entire media content based upon a binary artifact within the network site's HTML and provide the entire media content to the UE 102, based upon the user's preferences set within the browser or based upon the user providing an indication that the entire media content is desired. The proxy server 104 may also store the media content within the cache 116 of the proxy server 104 regardless of whether the entire media content is provided to the UE 102. When other users, via a UE 102, subsequently access the network site via the proxy server 104, the proxy server can provide the initial content of the media content via a data URI within the network site's HTML and can also, depending upon the subsequent user's preferences, provide the remaining portion of the media content to the subsequent user from the cache 116 within the proxy server 104, thereby improving page loading performance for the subsequent user. The media content can include, for example, images, video content and/or audio content.

If the media content stored in cache 116 is an image, the proxy server 104 can transcode the image into a progressive JPEG format and insert the transcoded image back into the cache 116. When subsequent users request the transcoded image, the proxy server 104 can send the first few kilobytes or layers of the progressive JPEG to the subsequent users. The first few kilobytes or layers of the progressive JPEG can be sent directly to the users that requested the first few kilobytes or layers of the progressive JPEG. The proxy server 104 can then start streaming the higher quality scans of the image that form the final JPEG to the subsequent users. In this manner, users gradually receive higher quality versions of the image.

Additionally, if subsequent users access the network site from which the transcoded image stored in the cache 116 was obtained, the proxy server 104 may embed the first few kilobytes or layers of the progressive JPEG as a data URI within HTML of the network site and forward the HTML with the embedded data URI to the subsequent users. The proxy server 104 can then start streaming the higher quality scans of the image that form the final JPEG to the subsequent users. In this manner, users gradually receive higher quality versions of the image.

### Example Processes

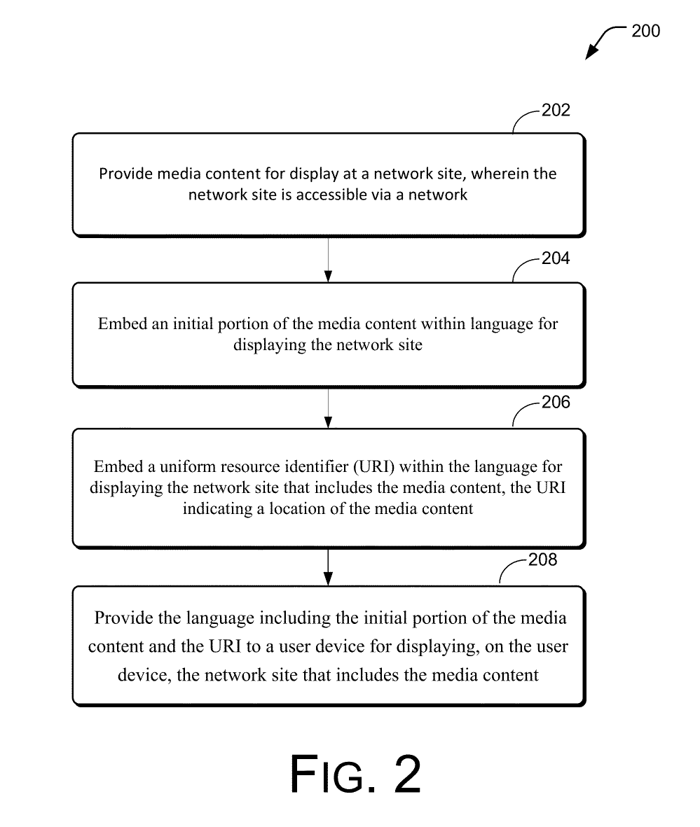

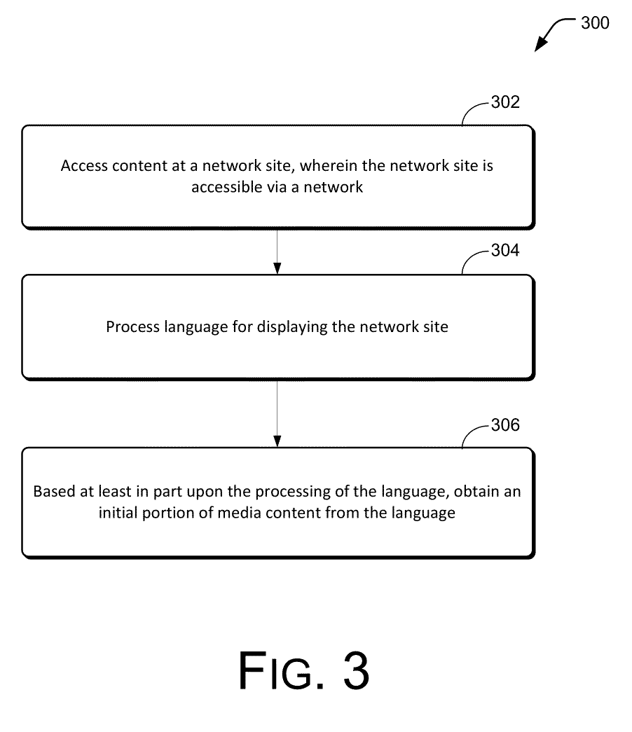

FIGS. 2 and 3 are flow diagrams of illustrative processes, of which one or more steps may be implemented by one or more processors. These processes (as well as other processes described throughout) are illustrated as logical flow graphs, each operation of which represents a sequence of operations that can be partly or wholly implemented in hardware, software, or a combination thereof. In the context of software, the operations represent computer-executable instructions stored on one or more tangible computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes. Furthermore, while the architectures and techniques described herein have been described with respect to servers and user equipments, the architectures and techniques are equally applicable to processors and processing cores in other environments and computing devices.

FIG. 2 illustrates a method 200 for providing media content from a network site to a user device, e.g., UEs 102. At 202, media content is provided for display at a network site, wherein the network site is accessible via a network. At 204, an initial portion of the media content is embedded within language for displaying the network site. At 206, a uniform resource identifier (URI) is embedded within the language for displaying the site that includes the media content. The URI indicates a location of the media content within the network. At 208, the language including the initial portion of the media content and the URI is provided to a user device for displaying, on the user device, the network site that includes the media content.

FIG. 3 illustrates a method 300 for receiving media content from a network site at a user device, e.g., UEs 102. At 302, content of a network site, accessible via a network, is accessed. At 304, language for displaying the network site is processed. At 306, based at least in part upon the processing of the language, an initial portion of media content is obtained from the language.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
providing media content for display at a network site, wherein the network site is accessible via a network;
embedding an initial portion of the media content within hypertext markup language (HTML) for displaying the network site;
embedding a uniform resource identifier (URI) within the HTML for displaying the network site that includes the media content, the URI indicating a location of the media content within the network; and
providing the HTML including the initial portion of the media content and the URI to a user device for displaying, on the user device, the network site that includes the media content.

2. The method of claim 1, wherein providing media content for display at a network site accessible comprises providing an image.

3. The method of claim 2, wherein the image comprises a progressive image.

4. The method of claim 1, wherein providing media content for display at a network site comprises providing at least one of video content and audio content.

5. Computer-readable media storing computer-executable instructions that, when executed on a processor, cause the processor to perform acts comprising:
embed an initial portion of media content within language for displaying content at a network site, wherein the network site is accessible via a network;
embed a uniform resource identifier (URI) within the language for displaying the content at the network site, the URI indicating a location of the media content within the network; and
provide the language including the initial portion of the media content and the URI to a user device for displaying the content on the user device.

6. The computer-readable media of claim 5, wherein the language comprises hypertext markup language.

7. The computer-readable media of claim 5, wherein the network comprises one of the Internet or an intranet.

8. The computer-readable media of claim 5, wherein the media content comprises an image.

9. The computer-readable media of claim 8, wherein the image comprises a progressive image.

10. The computer-readable media of claim 5, wherein the media content comprises at least one of video content and audio content.

11. A method comprising:
accessing content at a network site, wherein the network site is accessible via a network;
processing language for displaying the network site; and
based at least in part upon the processing of the language, obtaining an initial portion of media content from the language.

12. The method of claim 11, further comprising:
based at least in part upon the processing of the language, obtaining a uniform resource identifier (URI) from the language that indicates a location of the media content within the network; and
based at least in part upon the URI, obtaining at least a remaining portion of the media content.

13. The method of claim 13, further comprising utilizing a size of the initial portion as an offset for obtaining the remaining portion of the media content.

14. The method of claim 11, wherein the language comprises hypertext markup language.

15. The method of claim 11, wherein the network comprises one of the Internet or an intranet.

16. The method of claim 11, wherein the media content comprises an image.

17. The method of claim 16, wherein the image comprises a progressive image.

18. The method of claim 11, wherein the media content comprises at least one of video content and audio content.

19. Computer-readable media storing computer-executable instructions that, when executed on a processor, cause the processor to perform acts comprising:
access content at a network site, wherein the network site is accessible via a network;
process language for displaying the network site; and
based at least in part upon the processing of the language, obtain an initial portion of media content from the language.

20. The computer-readable of claim 19, wherein the acts further comprise:
based at least in part upon the processing of the language, obtain a uniform resource identifier (URI) from the language that indicates a location of the media content within the network; and
based at least in part upon the URI, obtain at least a remaining portion of the media content.

21. The computer-readable media of claim 20, wherein the acts further comprise utilizing a size of the initial portion as an offset for obtaining at least a remaining portion of the media content.

22. The computer-readable media of claim 19, wherein the language comprises hypertext markup language.

23. The computer-readable media of claim 19, wherein the network comprises one of the Internet or an intranet.

24. The computer-readable media of claim 19, wherein the media content comprises an image.

25. The computer-readable media of claim 24, wherein the image comprises a progressive image.

26. The computer-readable media computer-readable media of claim 19, wherein the media content comprises at least one of video content and audio content.
